(19) United States
(12) Patent Application Publication
(10) Pub. No.: US 2020/0273385 A1
(43) Pub. Date: Aug. 27, 2020

(54) ROAD SIGNS AND MARKINGS WITH LIGHT CONVERSION

(71) Applicant: MAGNA CLOSURES INC., Newmarket (CA)

(72) Inventors: John O'HARA, Newmarket (CA); J. R. Scott MITCHELL, Newmarket (CA)

(21) Appl. No.: 16/801,907

(22) Filed: Feb. 26, 2020

Related U.S. Application Data
(60) Provisional application No. 62/811,036, filed on Feb. 27, 2019.

(51) Int. Cl. G09F 13/16; F21V 13/08; F21V 7/00; F21V 7/30; F21V 9/32

(52) U.S. Cl. CPC G09F 13/16; F21V 13/08; G09F 2013/0472; F21V 7/30; F21V 9/32; F21V 7/0008

(57) ABSTRACT

A sign or other marking that is illuminated by an LED lamp, e.g., in a vehicle headlamp is described. The sign employs spectral shifting to increase the power or energy reflected by the sign when illuminated by the LED lamp, which has a significant power peak in the blue spectrum. The spectral shifting can be done in a conversion layer on top of a reflective layer. The reflective layer can include quantum dots to increase its efficiency in reflecting light.

This application claims the benefit of U.S. Provisional Application Ser. No. 62/811,036, filed Feb. 27, 2019, the entire contents of which are incorporated herein by reference.

### FIELD

The present disclosure relates to generally to devices illuminated by vehicle headlights, e.g., road signs and markings, having light conversion to enhance their visibility.

### BACKGROUND

Motor vehicle headlamps have shifted from using incandescent lamps and high intensity discharge lamps (e.g., xenon electrical gas-discharge lamps) to more electrically efficient light emitting diode (LED) lamps. LED lamps typically provide greater lumens for less electrical energy, e.g., by producing less infrared or red bandwidth light as well as less heat.

Headlamps, in addition to illuminating the roadway, illuminate road signs. In low ambient light conditions, the road signs reflect the headlamp emitted light that impinges the road sign. Typically, the road signs are passive and merely reflect the incident light.

### SUMMARY

This section provides a general summary of the present disclosure and is not a comprehensive disclosure of its full scope or all of its features, aspects and objectives.

In accordance with one aspect of the disclosure, a road sign including light shifting properties is described. The light shifting properties can include a layer of material configured to shift light incident on the road sign to match the reflective properties of the road sign.

In accordance with another aspect of the disclosure, a sign illuminated by a light source is provided, the light source configured to emit light in a spectral range. The sign comprises a base; and a light conversion material supported by the base and configured to receive the light emitted by the light source and to convert the light into a different spectral range.

In accordance with another aspect of the disclosure, the sign further comprises a light reflective material supported by the base, the light reflective material being less efficient at reflecting the light in the spectral range and more efficient at reflecting the light in the different spectral range.

In accordance with another aspect of the disclosure, the light reflective material reflects the light in the spectral range being a target spectral range, and the light conversion material converts the light into the target spectral range, wherein a combination of reflected light and converted light increases an illumination intensity of the sign.

In accordance with another aspect of the disclosure, the light conversion material is provided as a light conversion layer overlying the light reflective material, wherein the light conversion material emits light having a spectral range matching at least a dominant spectral wavelength of light reflected by the light reflective material.

In accordance with another aspect of the disclosure, the light generated by the light source is in a blue spectral range.

In accordance with another aspect of the disclosure, the light in the blue spectral range is generated by a light source configured as a blue light emitting diode.

In accordance with another aspect of the disclosure, the light conversion material is configured to up-convert the received light in the blue spectral range into a spectral range matching a spectral range of light reflected by the light reflective material.

In accordance with another aspect of the disclosure, the light conversion material converts light in the in a blue spectral range with a peak power in a range of 450-460 nm to above the range of 450-460 nm.

In accordance with another aspect of the disclosure, the light conversion material is configured to generate light in response a photoluminescent based excitation of the light conversion material by the received light.

In accordance with another aspect of the disclosure, the light conversion material comprises a plurality of quantum dot particles.

In accordance with another aspect of the disclosure, the light conversion material is provided as a light conversion layer on at least part of the light reflective layer, wherein the light reflective layer is configured to reflect the light converted into the different spectral range.

In accordance with another aspect of the disclosure, the light conversion material is intermingled with the light reflective material.

In accordance with another aspect of the disclosure, the base supports at least one of a background region and an information region next to the background region, wherein at least one of the background region and the information region is enhanced by the light conversion material.

In accordance with another aspect of the disclosure, the sign is configured as a road sign and the information region is configured for providing at least one of road instructions and road information.

The above aspects of the disclosure describe a road sign, however the present disclosure is applicable to other devices and structures illuminated by light emitted from LED sources. Such devices and structures include, but are not limited to roadway markings, non-roadway signs (e.g., parking lot, parking ramps, harbors, piers, docks, landing strips, taxiways and the like).

### BRIEF DESCRIPTION OF THE DRAWINGS

Other advantages of the present disclosure will be readily appreciated, as the same becomes better understood by reference to the following detailed description when considered in connection with the accompanying drawings wherein:

FIG. 1A is a schematic view of a vehicle and road sign in accordance with the disclosure;

FIG. 1B is a schematic view of a vehicle and road sign in accordance with the disclosure;

FIG. 1C is a schematic view of a vehicle and road sign in accordance with the disclosure;

FIG. 2 shows a graph showing spectral output of light from a vehicle LED headlamp;

FIG. 3A shows a graph of spectral output of light from a vehicle LED headlamp including the reflected light and non-reflected light from a road sign;

FIG. 3B shows schematic view of a conventional road sign illuminated by an LED headlamp;

FIG. 4A shows a graph of spectral output of light from a vehicle LED headlamp including the reflected light and converted and additional reflected light from a road sign;

FIG. 4B shows a schematic view of a road sign with light conversion illuminated by an LED headlamp;

FIG. 5 shows a boundary defined road sign with light conversion in accordance with the present disclosure;

FIG. 6 shows a schematic view of the reflected light intensity of the FIG. 5 road sign in accordance with the present disclosure;

FIGS. 6A, B, and C show light output charts of the reflected light intensity of a road sign in accordance with the present disclosure;

FIG. 7 shows a road sign with light conversion at a boundary spacer in accordance with the present disclosure;

FIG. 8 shows a schematic view of the reflected light intensity of the FIG. 7 road sign in accordance with the present disclosure;

FIG. 9A shows a graph of spectral output of incandescent light;

FIG. 9B shows a road sign in accordance with the present disclosure;

FIG. 9C shows a road sign in accordance with the present disclosure;

FIG. 10 shows a road sign with light conversion in multiple zones in accordance with the present disclosure;

FIG. 11 shows a schematic view of the reflected light intensity of the FIG. 10 road sign in accordance with the present disclosure;

FIG. 12 is a cross sectional view taken generally along line 12-12 in FIG. 10;

FIG. 13 shows a method of illuminating a marking into accordance with the present disclosure;

FIGS. 14 and 15 are side views of a vehicle having a headlight assembly equipped with a light emitting device illuminating illustrative examples of road markings in accordance with the disclosure;

FIG. 16 is a color spectrum graph illustrating a spectral output of a photo luminescent material in response to excitation by the light input from a light emitting device; and

FIG. 17 is a top view of a vehicle on a roadway having road markings, in accordance with aspects of the present disclosure.

### DETAILED DESCRIPTION OF EXAMPLE EMBODIMENTS

In general, example embodiments of road signs having a light shifting capability in accordance with the teachings of the present disclosure will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the present disclosure. In some example embodiments, well-known processes, well-known device structures, and well-known technologies are not described in detail, as they will be readily understood by the skilled artisan in view of the disclosure herein.

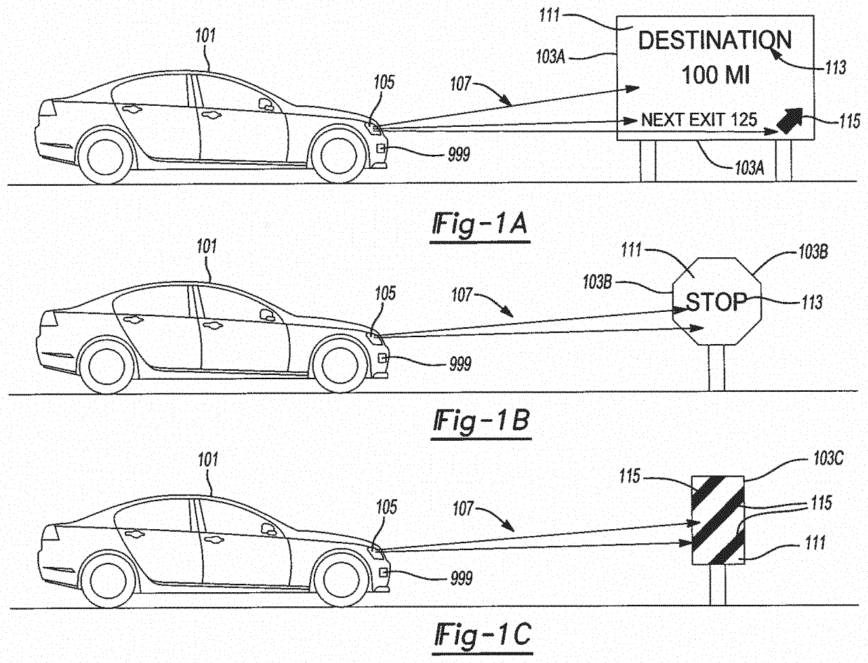

FIG. 1A shows a schematic view of a vehicle 101 and road sign 103 in accordance with the disclosure. The vehicle 101 includes headlamps 105 that emit light 107 to illuminate the region in front of the vehicle. The headlamps can illuminate the roadway as well as structures, such as signs 103A-103C, in front of the vehicle. The sign 103A, 103B, or 103C reflects a portion of the headlamp emitted light 107, which allows people to see and read information on the sign. Vehicles have used various types of headlamps over the years. Vehicles have been moving toward using LED headlamps as these have become more reliable and efficient relative to prior headlamps, e.g., incandescent lamps. However, the LED lamps have a different color spectrum output relative to incandescent lamps. The LED light is shifted more toward the blue spectra with a significant power distribution in a blue range relative to incandescent lamps, which emit light with more power in a red range.

Road signs 103A, 103B, 103C may be made according to governmental regulatory bodies, e.g., the USA Federal Highway Administration, Transport Canada, and other similar regulatory bodies around the world. Such regulatory bodies may define the size, shape, and color of road signs. See, e.g., the Manual on Uniform Traffic Control Devices, which sets forth road sign requirements as set forth in 37 CFR 655. These include the chromaticity requirements and luminance requirements, for both daytime and nighttime, for road signs. Road signs 103A-103C may include text, symbols and shapes set in a background. Road sign 103A includes a main background region 111 in which a first, text region 113 (here, text for an exit “Destination, 100 mi, Next Exit 125”) is positioned along with a second, graphic region 115. The first region 113 may be discontinuous within the main region 111 and have the same reflective properties. A road sign may include a plurality of different regions, which may each have different reflective properties. The light 107 from the lamp 105 impinges on the background region 111, the first region 113 and the second region 115 and is reflected back from the sign 103. Different colors, e.g., chromaticity, and intensity are reflected from the different regions 111, 113, 115 of the sign 103. During a period of reduced or no ambient sunlight, the reflected light depends on the properties of the light from the lamp 105 and the properties of the different regions on the sign 103. Referring to FIG. 1B, road sign 103B includes the main background region 111 in which the first, text region 113 (here, text for “STOP”) is positioned. Referring to FIG. 1C, road sign 103C includes the main background region 111 in which one or more graphic regions 115 (here, diagonal lines) is positioned. In an example embodiment, the main background 111 can be a different color than either or both the first and second regions 113, 115. In an example embodiment at least one of the regions 111, 113, 115 includes a different intensity than the other regions. That is, one of the regions 111, 113, 115 will be perceived by a person to be brighter than another region such that a person will perceive a greater contrast between the regions. With an increase in brightness, a person may perceive the sign, and, hence, the information conveyed by the sign at a greater distance.

Road signs 103 may include retroflectors, which can be a structure that reflects light back to the source with a minimum of scattering. A retroreflector reflects light back along a vector that is parallel to but opposite in direction from the light source. Retroreflectors may include corner reflectors, cat's eye reflectors, and the like. Retroreflectors can be small versions of these structures embedded in a thin sheet or in paint. Road signs 103 can further include quantum dots to dope reflective surfaces to enhance the overall visibility of the sign, which can enhance the readability of the text or symbol on the sign. Quantum dots can be nanometer size particles whose energy states in the material of the quantum dot are dependent on the size of the quantum dot. For example, in semiconductors, quantum dots are closely related to the size and shape of the individual semiconductor crystal. Generally, the smaller the size of the crystal, the larger the band gap, the greater the difference in energy between the highest valence band and the lowest conduction band becomes. Therefore, more energy is needed to excite the dot, and concurrently, more energy is released when the crystal returns to its resting state. Quantum dots represent one way to up convert ultraviolet light to a targeted color emission, for example a green light emission or red light emission. The reflectors only reflect the amount of light present in the light source that matches the wavelength of the color of the sign. Therefore, the reflector brightness will depend on light source and reflector color. Regardless, only a portion of the incident light is reflected while the majority of the light is absorbed by the sign. This can be a significant problem for signs when illuminated by LED lamps, which has a narrower power distribution than incandescent and halogen lamps with the added drawback that that power band of LED lamps is in the blue spectra and not in the red spectra.

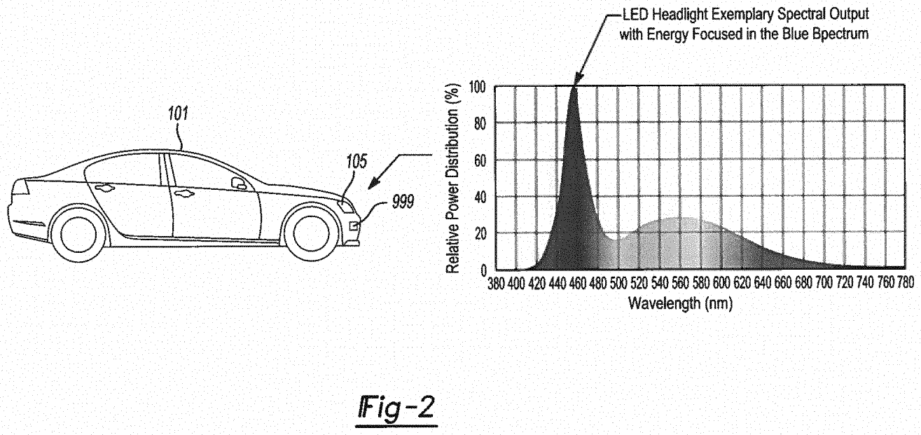

FIG. 2 shows a graph 200 of spectral output of light from a vehicle 100 LED headlamp 105. The graph 200 shows relative power distribution as a percent (ordinate) versus the wavelength of the light (abscissa) in nanometers (nm). As shown in FIG. 2, the spectrum in graph 200 shows a significant peak in power indicated at 202 in the blue spectra, e.g., about 100% at about 450-460 nm (+/−10 nm) in wavelength. There is relatively little power in the yellow and red spectra. The example spectral output of an LED headlamp has energy focused in the blue spectrum because the energy of an LED lamp is concentrated in the blue light spectra. This is significantly different from sunlight, which typically has a high power across the entire visible (human visible) spectrum, i.e., from 390 nm to 700 nm. This is also significantly different from traditional incandescent light sources, which have a low relative power in the blue spectra with significant power in the red spectra. The incandescent/halogen sources can also produce significant infra-red radiation, which produces heat. The incandescent/halogen sources also avoid significant peaks, less than an order of magnitude or 10% change from one color band to the adjacent color band. Relative to the LED, the incandescent/halogen sources have a relative spectral power of about 15-20%.

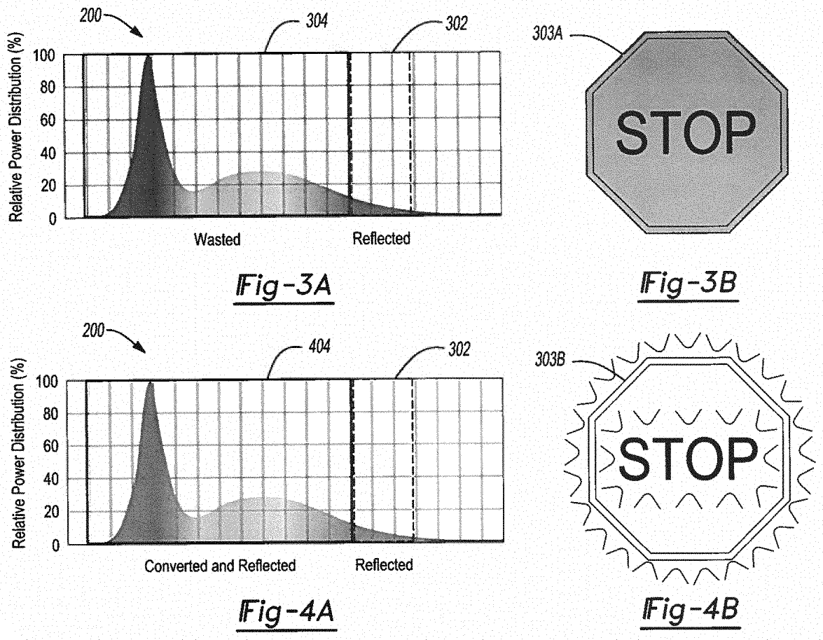

FIG. 3A shows a graph 200 of spectral output of light from a vehicle LED headlamp including the reflected light spectrum 302 and non-reflected light spectrum 304 from a road sign 303A (FIG. 3B), which can be similar to the road sign 1038, The road sign 303A can be stop sign with the mainly painted red with a contrasting region spelling the word “stop”. The road sign 303A is illuminated by light from an LED headlamp, e.g., lamp 105. The light spectrum 302 is reflected from the sign 303A. The reflected light spectrum 302 is the light spectrum that matches the color of the sign 303A, here a red stop sign. However, the power in the red spectrum from the LED lamp is low relative to the blue-orange spectra, as well as low compared to sunlight and traditional headlamps, e.g., incandescent, halogen, and high-intensity discharge (HID) lamps. This results in a stop sign that is not as bright objectively (or subjectively to an observer) due to less light power being reflected from the sign. The light in the spectrum 304 is not reflected by the sign 303A and is filtered by the sign; that is, only a small portion of all light produced by the LED headlamp is reflected back towards the observer. The majority of the spectrum is filtered out and absorbed. Thus, the light in spectrum 304 is essentially wasted as to illuminating the sign 303. As shown, the spectrum 302 has significantly less power than the spectrum 304. This results in a less bright sign 303A.

FIG. 4A shows a graph 200 of spectral output of light from a vehicle LED headlamp including the reflected light spectrum 302 and converted and additional reflected light spectrum 404 from a road sign 303B (FIG. 4B). The light spectrum 200 is the same as that described with reference to FIGS. 2 and 3A. However, the sign 303B unlike sign 303A includes a light conversion material that converts at least a portion of the spectrum 404 into a sign color wavelength that is reflected and not filtered by the sign 303B. The sign 303B reflects more light and is brighter than the sign 303A when illuminated by the LED lamp 105. In an example embodiment, the blue wavelengths, e.g., about 400 nm-480 nm, are upconverted to a wavelength of about 625 nm-740 nm. Thus, the energy in the spectral peak at about 450 nm is now being reflected by the sign 303B. By adding light conversion material to a reflective portion of the sign 303B (e.g., a perimeter line and the text “STOP”), the incident light that was previously absorbed by the sign is converted to the sign color wavelength and reflected. This will increase the brightness and visibility of the sign 303B.

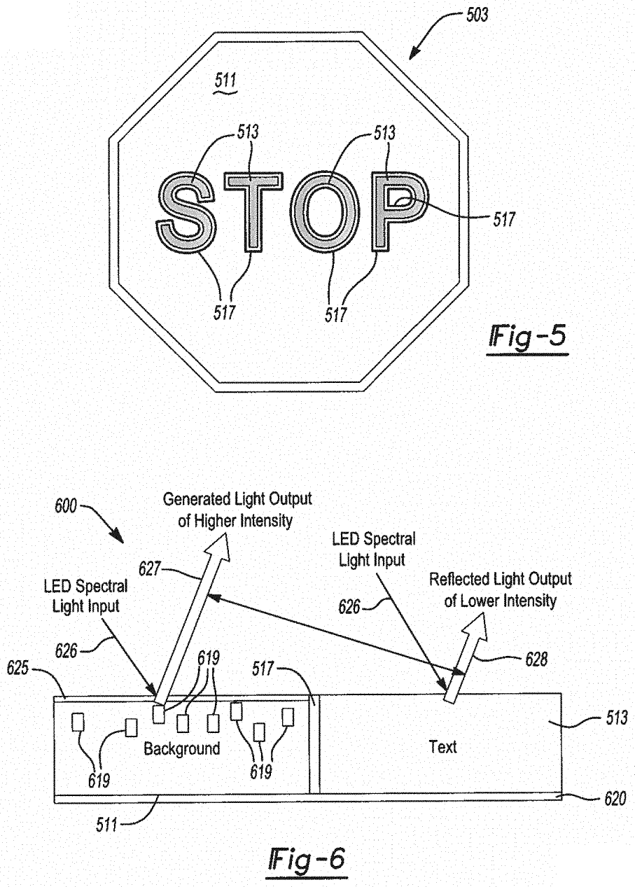

FIG. 5 shows a boundary defined road sign 503 with light conversion in accordance with the present disclosure. The road sign 503 includes a base to support a background region 511 in which a text, information region 513 is positioned. The background region 511 can extend to the edges of the sign and be painted with a background paint color enhanced with quantum dot (Qdot) material selected to be responsive to headlight LED spectral output. The background paint color enhanced with Qdot material reflects light, for example, red blue, or green according to governing regulations. For a stop sign, the sign background region 511 is in the red spectrum, e.g., as described above with regard to FIGS. 3A, 3B, 4A and 4B. It is within the scope of the present disclosure to color the background region in any color assigned to a particular sign. The information region 513 may be colored in a manner that contrasts with the color of the background region. The information region 513 may be letters, numbers, shapes, and the like, to convey information to an observer, e.g., a vehicle driver or passenger. The information region 513 may not include Qdots, in an example embodiment, to further contrast with the background region.

A boundary region 517 may extend along the perimeter of the parts of the information region 513. The boundary region 517 can extend along all of the information region 513 to separate and define the information region relative to the background region 511. The information region 513 and the background region 511 do not touch and are not directly adjacent to each other as they are separated by the boundary region 517. The boundary region 517 may include Qdots in an example embodiment. The boundary region 517 may provide a high contrast boundary between a reactive background region 511 responsive to LED illumination (i.e., a region with a conversion layer to spectrally shift the light before reflection) and a non-reactive, non-conversion, information region 513 that is not excitable by LED material and therefore merely reflective without spectral shifting of light. The boundary region 517 provides a higher contrast between the background region 511 and the text region 513. This may enhance visibility and legibility for people from distances through the use of an increased background brightness with an optional boundary region.

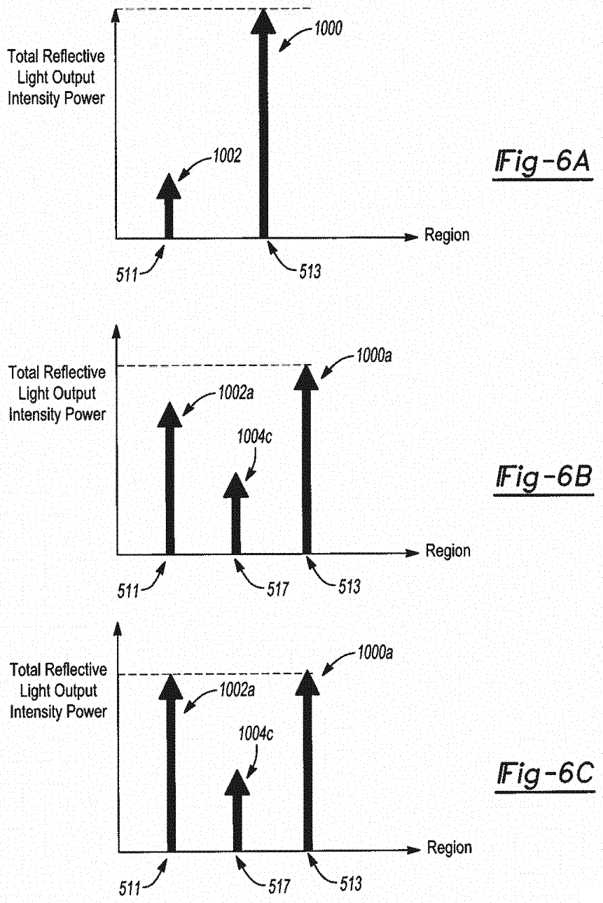

FIG. 6 shows a schematic partial view 600 of the reflected light intensity of the FIG. 5 road sign 503 in accordance with the present disclosure. A base 620 supports the background region 511, the information region 513 and the boundary region 517. The base 620 can be a rigid material, e.g., metal, wood, or a rigid polymer. In a possible configuration, at least one of the background region 511, the information region 513 and the boundary region 517 may be configured to act as the base 620. The base 620 can be mounted to a support, such as a pole, overpass, station and the like. The layers are not shown to scale but are shown schematically to more readily illustrate the regions 511, 513, and 517. The background region 511 includes a plurality of Qdots 619 therein. The Qdots 619 can increase the reflective power of the background layer and may further change the angle at which the light is reflected. A light conversion layer 625 is positioned over the background region 511 on a side opposite the base 620. The light conversion layer 625 receives the light input 626 before the background region 511. The light conversion layer 625 converts the light to the spectral range to more closely match the color and reflective properties of the background region 511. The background region 511 will reflect a quantity of light represented by arrow 627. The information region 513 and the boundary region 517 will receive the same light as the background region 511. However, the information region 513 and the boundary region 517 both lack the conversion layer 625 and Qdots 619. As a result, the information region 513 and the boundary region 517 reflect less light, e.g., arrow 628 from information region 513 relative to the light reflected from the background region 511. The arrow 628 is shown as smaller to represent that the light reflected from information region 513 is less (measured as power, intensity, brightness, lumens or combinations thereof) relative to the light reflected from the background region. The light output differences between the background region 511 and the information region 513 creates contrast between background and information (e.g., text, numbers, symbols or shapes) to increase visibility of the information for improving readability when the background luminosity is also increased by light conversion and the Q-dot light output. Contrast differences between text and background further improves the readability of the text by a monochromatic imaging system 999, e.g., a camera, of a vehicle 101, for example configured to read road signs and recognize text for controlling a vehicle system, for example an alert system or autonomous vehicle control system.

Now referring to FIG. 6A, there is illustrated a reflected light intensity chart of the road sign 503 (FIG. 5) without a boundary region 517 in order to increase contrast of the information region 513 relative to the background region 511. Information region 513 and the background region 511 include a tunable conversion layer 625 and Qdots 619. Information region 513 may be tuned to provide a greater light intensity output 1000 compared to the background region light intensity output 1002. As a result, the overall light intensity of the road sign 503 is increased, while providing contrast intensity between different regions of the sign. Now referring to FIG. 6B, illustrated is reflected light intensity chart of the FIG. 5 road sign 503 with a boundary region 517 in order to increase contrast of the information region 513 relative to the background region 511. Information region 513 and the background region 511 include a tunable conversion layer 625 and Qdots 619. Information region 513 may be tuned to provide a greater light intensity output 1000a compared to the background region light intensity output 1002a. The boundary region 517 lacks the conversion layer 625 and Qdots 619, or is provided with the conversion layer 625 and Qdots 619 having a lower total light intensity output (1004c) compared adjacent information region 513 and background region 511. As a result, the background region 511 and the boundary region 517 reflect less light compared to the information region 513, thereby increasing the light output intensity of the Information region 513. Light intensity output 1002a and light intensity output 1000a may be provided with less difference or essentially the same to normalize the light output of the sign 503 across all regions, as illustrated in FIG. 6C. FIG. 6C illustrates the boundary region 517 without a conversion layer 625 and Qdots 619 and therefore the light output is dependent on light reflection of the background, The total light intensity outputs of each region may include the naturally reflected light intensity due to the colour of the region, enhanced with the additional light intensity provided by the conversion layer 625 and Qdots 619.

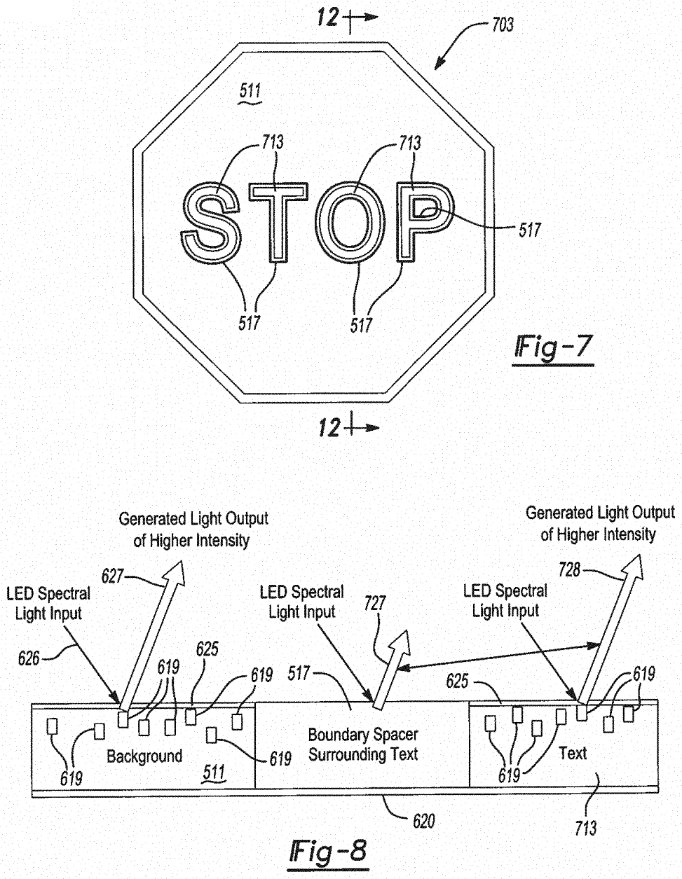

FIG. 7 shows a road sign 703 with light conversion at a boundary spacer in accordance with the present disclosure. The road sign 703 is the same as the road sign 503 except that the information region 513 is replaced by an information region 713 that includes Qdots to enhance its reflective performance. The light conversion layer 625 extends over the information region 513.

FIG. 8 shows a schematic view 800 of the reflected light intensity of the FIG. 7 road sign 703 in accordance with the present disclosure. The light conversion layer 625 is configured to shift the light from the LED lamp to match the color and reflective properties of the information region 713. The light conversion layer 625 may have different properties over the different regions 511, 713 as the conversion layer may need to shift the blue spectrum LED lamp light to a different wavelength. The light reflected from the background region 511, the boundary region 517, and the information region 713 is represented schematically by arrows 627, 727 and 728, respectively.

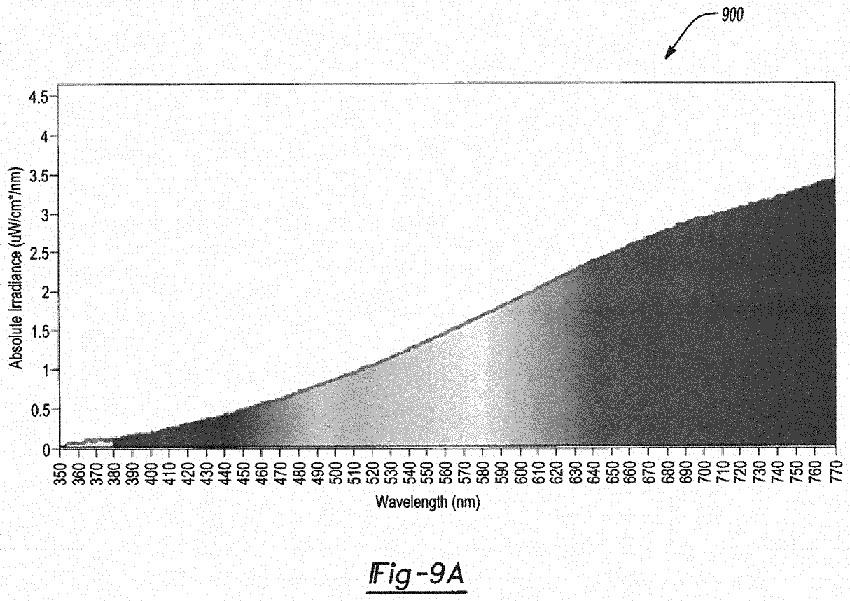

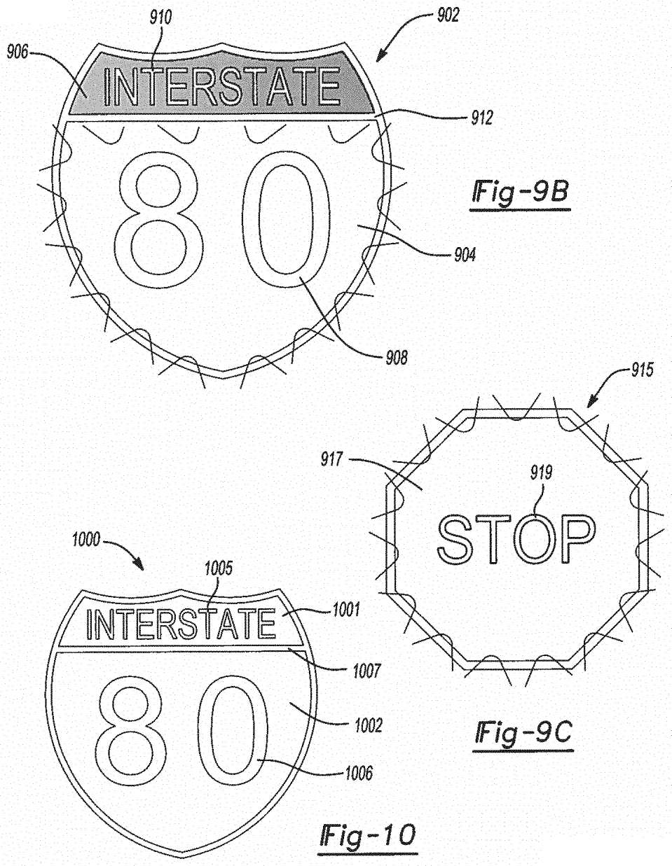

FIG. 9A shows a graph 900 of spectral output of incandescent light. The graph 900 shows that the power in an incandescent light source as measured as absolute radiance versus wavelength has less power in the purple and blue spectral regions than in the red spectral region. Most signs, road markings and vehicle related markings take into account this spectral power to provide adequate brightness. This is different than the LED power distribution shown in FIG. 2 and described herein. Thus, the present disclosure describes a need to shift the light coming from an LED source to provide adequate brightness of the reflected light from signs, road markings and vehicle related markings, which are not all blue in color.

Referring now to FIG. 9B, the USA interstate highway sign 902 includes three colors, blue, red and white. The background region is divided into two regions, the large region 904 being blue and the top, smaller region 906 being red. The information region includes two sub-regions 908, 910, which are in the large background region 904 and the small background region 906, respectively. A boundary region 912 is provided around the outside of the sign 902 and between the background regions 904, 906. Under standard incandescent light, the blue background region 904 will be dimmer than the red background region 906. Under LED light, the blue background region 904 will be brighter than the red background region 906, as shown in FIG. 9B, than when lit by incandescent light.

Referring now to FIG. 9C, the USA stop sign 915 includes two regions, a red background region 917 and a white information region 919. Under incandescent light, the stop sign 915 will appear brighter as shown in FIG, 9C, than when lit by an LED light source, e.g., an LED lamp. Under LED light, the stop sign 915 will appear dim as there is less power in the red spectrum relative to incandescent light.

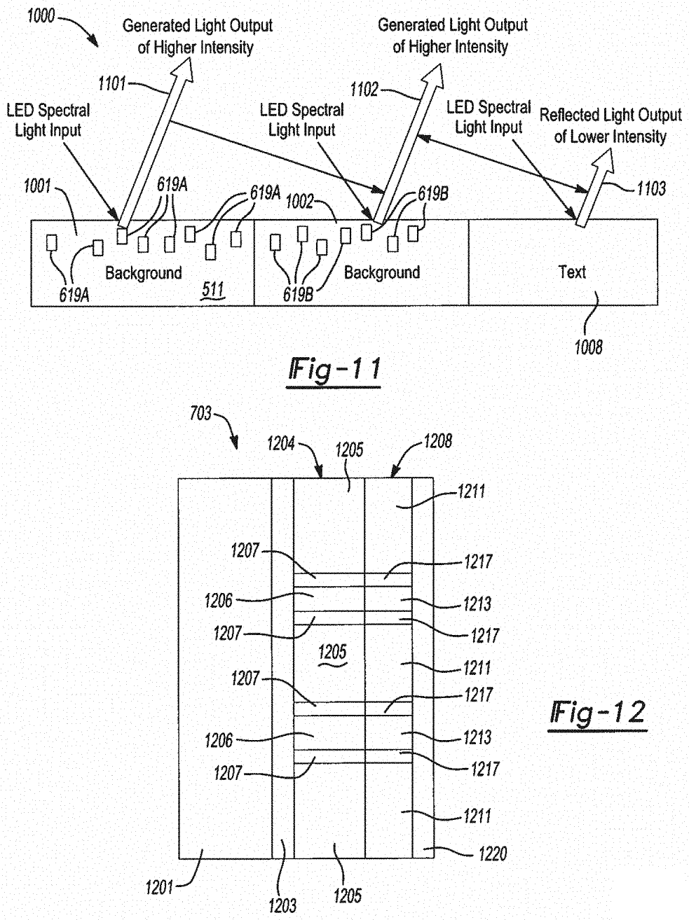

FIG. 10 shows a road sign 1000 with light conversion in multiple zones in accordance with the present disclosure. The road sign 1000 is shown as a USA interstate highway sign with multiple background regions 1001, 1002 and multiple information regions 1005, 1006 with a boundary region 1007 around the periphery and between the first background region 1001 and the second background region 1002. An information region 1008 is provided with at least one of the background regions 1001, 1002. The first background region 1001 is above the second background region 1002. The first background region 1001 is red and may appear dimmer if an LED light source is used to illuminate the sign relative to an incandescent light. The second region 1002 is blue and may appear brighter if an LED light source is used to illuminate the sign relative to an incandescent light. Both the background regions 1001, 1002 can include Qdots 619A, 619B, as illustrated in FIG. 11. The quantity of Qdots 619A, 6196 can be different for each region 1001, 1002. The quantity of Qdots 619A in the first background region 1001 can be greater than the quantity of Qdots 6196 in the second background region 1002 to attempt to equalize the light reflected from the two background regions 1001, 1002 region. The background regions 1001, 1002 can also have different types of Qdots 619A, 619B therein. The information regions 1005 and 1006 can be free of Qdots or include different Qdots than the background regions 1001, 1002. This will result in the information regions 1005 and 1006 having a different reflected light property than the background regions 1001, 1002, The boundary region 1007 can be free of Qdots or include different Qdots than the background regions 1001, 1002. This will result in the boundary region 1007 having a different reflected light property than the background regions 1001, 1002.

FIG. 11 shows a schematic view of the reflected light intensity of the FIG. 10 road sign 1000 in accordance with the present disclosure. The two background regions 1001, 1002 both include Qdots 619A, 619B, which may assist in leveling the amount of reflected light from the background regions 1001, 1002 as schematically shown at arrows 1101, 1102. The Qdots 619A, 619B are tuned to the respective region to attempt to equalize the light reflected from both background regions. In an example embodiment, the region that is not reflective in the blue spectral range can include a conversion layer to shift the light to the color of that region. The information regions 1005, 1006 reflect a lower intensity of light as schematically shown at arrow 1103 relative to the background regions 1001, 1002.

FIG. 12 is a cross sectional view taken generally along line 12-12 in FIG. 7. A base 1201 is provided to support the other layers and provide a planar surface on which the other layers can be adhered. The base 1201 can be a rigid material, e.g., metal, wood, or a rigid polymer. The base 1201 can be mounted to a support, such as a pole, overpass, station and the like. The base 1201 is coated with a primer layer 1203 to provide a surface on which subsequent layers can be adhered. A background layer 1204 is applied to the primer layer 1203. The background layer 1204 can include a plurality of sections 1205, 1206, 1207, which are each individually doped with pigment to color the individual sections as required in the sign design. Some of the sections 1205, 1206 can also include Qdots therein. In the case of a stop sign according to USA FHWA regulations, this background section 1205 is red. The information section 1206 is positioned adjacent the background section 1205 and includes pigments that are different than the background section 1205. The information section 1206 may include Qdots as described herein. In the case of a stop sign according to USA FHWA regulations, this information section 1206 is white. A boundary section 1207 is intermediate the background section 1205 and the information section 1206. The boundary section 1207 is positioned in the background layer 1204 and includes pigments that are different than the background section 1205 and the information section 1206. The boundary section 1207 does not include Qdots to provide a contrast to the background section 1205 layer and the information section 1206. The layers and sections are not shown to scale but are shown schematically to more readily illustrate the different layers and sections.

A conversion layer 1208 is on the background layer 1204. The conversion layer 1208 can include sections that correspond to the sections in the background layer 1204. A first conversion section 1211 is on the background section 1205. The first conversion section 1211 is tuned to convert the LED light to a spectrum range that will more efficiently reflect off the background section 1205. For example, in the case of a stop sign, the blue in the LED light is shifted to a red range at a longer wavelength. This will increase the light being reflected from the background section 1205. A second conversion section 1213 is applied on the information section 1206. The second conversion section 1213 is tuned to convert the LED light to a spectrum range that will more efficiently reflect off the information section 1206. For example in the case of a stop sign, the blue spectrum in the LED light is spread across a broader spectrum to provide a brighter reflection from the white information section 1206. A second boundary section 1217 is on the boundary section 1207. The second boundary section 1217 is transparent and does not color shift the LED light. The second boundary section 1217 is provided to keep the outward surface fiat. A seal coat 1220 can be provided on the conversion layer 1208. In this example embodiment, the background region is formed by the background section 1205 and the first conversion section 1211. The information region is formed by the information section 1206 and the second conversion section 1213. The boundary region is formed by the boundary section 1207 and 1217.

The foregoing description of the embodiments describes some embodiments with regard to vehicles and road signs. These are used for convenience of description. The present disclosure is applicable to structures and devices that are illuminated by LED light sources to provide greater visibility of structures and devices in low light conditions, e.g., non-daylight or during a storm. Such devices and structures can include license plates, paint markings, markers, buoys, piers, pilings, ship markings, markings on vehicles themselves and the like. The term vehicles as used herein includes any vehicle for transporting people, animals or goods. The vehicles can include, but is not limited to, passenger vehicles, vans, motorcycles, scooters, bicycles, pickup trucks, buses, semi-trucks, vessels, boats, ships, aircraft, airplanes, gliders, helicopters, drones, trains, subways, trolleys, trams, amphibious vehicles, snow machines, and the like. Vehicles can be driven by a person or autonomous, e.g., unmanned.

Embodiments of the present disclosure may improve the visibility of road signs at night or under low sunlight conditions. The reduction of visibility can be a result of the sign color, type of lamp, e.g., headlights, or both. Some embodiments provide an increase visibility of road signs, road markings or other signs and markings that are illuminated by lamps. The signs and markings may include light shifting layers or components to shift the light spectra to a region that matches the reflective properties of the sign or structure. This will increase the quantity of light being reflected by the sign or marking. For example, if the lamp has a significant power in a blue spectra, e.g., a peak at about 450 nm and the sign is perceived as red, then the sign will not appear as bright relative to when a lamp with greater power in the red wavelengths illuminates the sign. Thus, the sign may color shift the blue light into a red spectra to increase the power reflected from the sign or structure. By adding a layer of light converting material to the sign or structure, a greater amount of incident light is converted to the sign color and reflected back, thus greatly enhancing visibility of road signs, road markings and other reflective structures.

The regulations for signs and markings for vehicle travel is based on incandescent light sources, e.g., the incandescent/halogen headlamps on motor vehicles. However, there is a move to LED lamps, which emit a different light spectrum. The light spectrum of LED lamps is shifted to blue and may include a power peak in the blue spectrum, which was not present in the incandescent light from traditional lamps. Thus, signs and markings may appear differently to a person when illuminated by LED lamps. Accordingly, signs and markings may be improved if light is converted at the sign to match the reflective properties of the sign. This may improve travel safety by having signs appear brighter or at least stay as close to prior reflective properties when illuminated by incandescent sources.

It is desirable to includes the brightness of signs and markings to assist people in seeing and comprehending the information conveyed by signs and markings. This is important in low light and bright light conditions. The human eyes perceive light and color differently in bright light conditions and low light conditions. The cone cells in the human eyes are the predominant light receptors in bright light. The rods in the human eyes are the low light receptors. Vision can be broken into three paradigms. Photopic vision occurs in bright light, e.g., >10 Cd/m². In photopic vision three types of cone cells with max absorption at 420 nm (blue), 534 nm (bluish-green), and 564 nm (yellowish-green) and a maximum efficiency is 683 lm/W at a wavelength of 555 nm (green) are used. Mesopic vision occurs in medium low light at about 10 to 10⁻³ Cd/m² and uses both cones and rods. Scotopic vision occurs in low light, e.g., <10⁻³ Cd/m²) uses two types of rods and no cones. Scotopic vision only measures rate of absorption of light, not the spectral distribution, i.e., black and white vision. Scotopic vision has a maximum efficiency around 500 nm with slight blue shift. It is desirable to increase brightness of reflected light and provide the ability of a person to perceive the colors under all vision conditions.

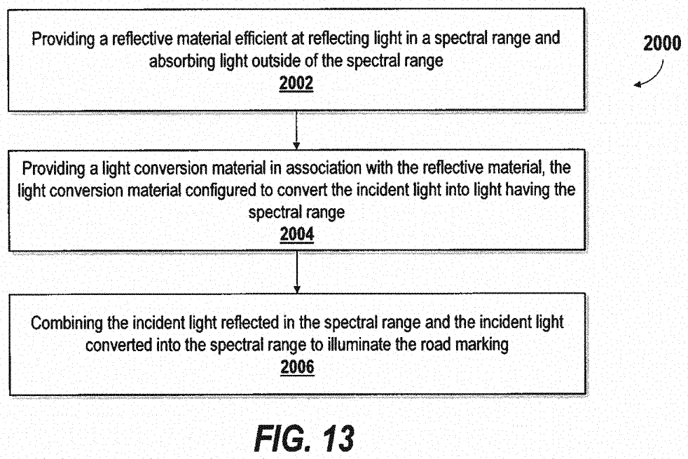

Now referring to FIG. 13, in addition to FIGS. 1 through 12, there is provided a method 2000 of increasing an illumination intensity of a road marking illuminated by incident light emitted by a light source, including the steps of providing a reflective material efficient at reflecting light in a spectral range and absorbing light outside of the spectral range 2002; providing a light conversion material in association with the reflective material, the light conversion material configured to convert the incident light into light having the spectral range 2004; and combining the incident light reflected in the spectral range and the incident light converted into the spectral range to illuminate the road marking 2006. For example, such combination may be a result of light generated by the light conversion material, the light generated light conversion material and as reflected by the reflective material, and by the incident light reflected by the reflective material, or a sub-combination thereof. Compared to existing road signs only illuminated by its passive reflective properties, the road signs/markings described herein enhanced with active light converting material may increase the visibility of the road signs/markings by converting received incident light into a spectrum the road signs/markings may more efficiently output, such as for example due to reflection or by direct propagation of light towards a viewer of the sign. The step 2004 may include configuring the light conversion material to up-convert the incident light, and for example may include configuring the light conversion material to up-convert the incident light emitted by a blue LED, or UV LED.

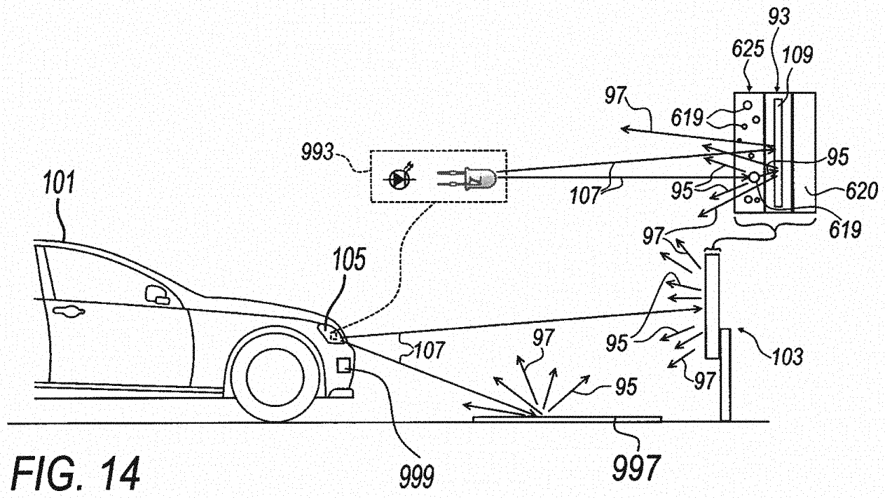

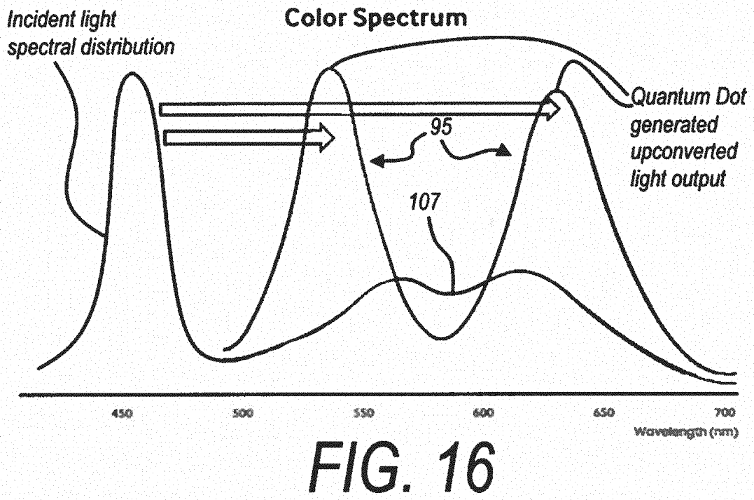

Now referring to FIG. 14, in addition to FIGS. 1 through 13, there is provided a diagrammatic illustration of the sign 103 illuminated by the light source 105, the light source 105 configured to emit light 107 in a spectral range, the sign 103 including a base 620 and a light conversion material 619, 625 supported by the base 620 and configured to receive the light 107 emitted by the light source 105 and to convert the light 107 into a converted light 95 having a different spectral range, for example as shown in FIG. 16 through the illustrative process of photoluminescence as described herein above in more details. The light conversion material 619, 625 may be configured to up-convert the light 107 generated in a lower spectral range, such as the blue or UV range which may be generated by low power light emitting devices, such as light emitting diodes, to higher spectral ranges such as in the ranges corresponding to red colors, yellow colors, green colors and the like. The sign 103 may further include a light reflective material 109, which may be such as the reflector and retroflector structures described herein above, supported by the base 620. In one possible configuration the reflective material 109 may be a paint, in another possible configuration the reflective material 109 may be embodied as light reflective structures, such as retroreflective glass beads, microprisms, or encapsulated lenses sealed within substrate such as a paint, a fabric or plastic, or as part of other like supporting structures, as illustrative examples only. The light reflective material 109 may be less efficient at reflecting the light 107 in the spectral range, for example being more efficient at absorbing the light 107 in the spectral range, and more efficient at reflecting the light 107 in the different spectral range. The light reflective material 109 may be configured to reflect the light 107 in the spectral range being a target spectral range, such as a spectral range defining a predetermined color such as a red, green, yellow, for example a color having a color spectral distribution (e.g. defined by a dominant wavelength) conforming to the local traffic signage laws and regulations, and the light conversion material 619, 625, converts the light 107 into the target spectral range, wherein a combination of reflected light 97 and converted light 95 increases an illumination intensity of the sign 103. The light conversion material 619, 625, may be provided as a light conversion layer 625 overlying the light reflective material 109, wherein the light conversion material 619, 625, emits light, for example as a result of a conversion process such as a photoluminescence process, having a spectral range matching at least a dominant spectral wavelength of the light 107 reflected by the light reflective material 109. Such output color matching may be performed in other manners, such as an exact tuning of the spectral curves, or by an averaging of the spectral peaks, or by the dominant wavelength as examples only. The light 107 generated by the light source 105 may be in a blue spectral range. The light in the blue spectral range may be generated by a light source configured as a blue light emitting diode 993. A light emitted diode configured to emit ultraviolent light may also be provided as part of the light source 105 to stimulate or excite the light conversion material 619, 625. The light conversion material 619, 625, may be configured to convert the received light 107 in the blue spectral range into a spectral range matching a spectral range of light reflected 97 by the light reflective material 109. The light conversion material 619, 625, may be configured to convert light 107 in the blue spectral range with a peak power in a range of 450-460 nm to above the range of 450-460 nm. The light conversion material 619, 625, may be configured to generate light 95 based excitation of the light conversion material 619, 625 by the received light 107 due to a photoluminescence process as an example. The light conversion material 619, 625 may be provided as a plurality of quantum dot particles according to one illustrative configuration. The light conversion material 619, 625 maybe provided as a plurality of perovskite particles. The light conversion material 619, 625 maybe provided as other kinds of excitable particles, such as nanoparticles, configured to generate light as a result of an externally originating source of excitation. The light conversion material 619 may be provided as part of a light conversion layer 625 (e.g. intermingled or distributed therein) on at least part of a light reflective layer 93 formed from the light reflective material 109, wherein the light reflective layer 93 is configured to reflect the light 95 converted into the different spectral range, and also may be configured to reflect the incident light 107 in the form of reflected light 97. For example the light reflective layer 93 may be structured as a plurality of microprisms, or lenses as non-limiting examples.

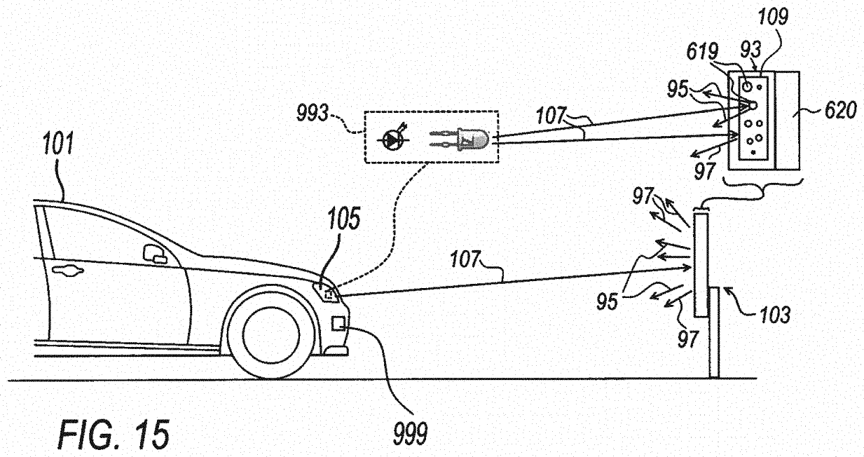

Now referring to FIG. 15, in addition to FIGS. 1 to 14, the light conversion material 619 may be intermingled with the light reflective material 109 for forming a composite light reflective/generative structure. For example, the light conversion material 619, 625 may be combined with the light reflective material 109 as part of a blended molding process or other manufacturing process e.g. layer deposition. Other types of composite structures are possible.

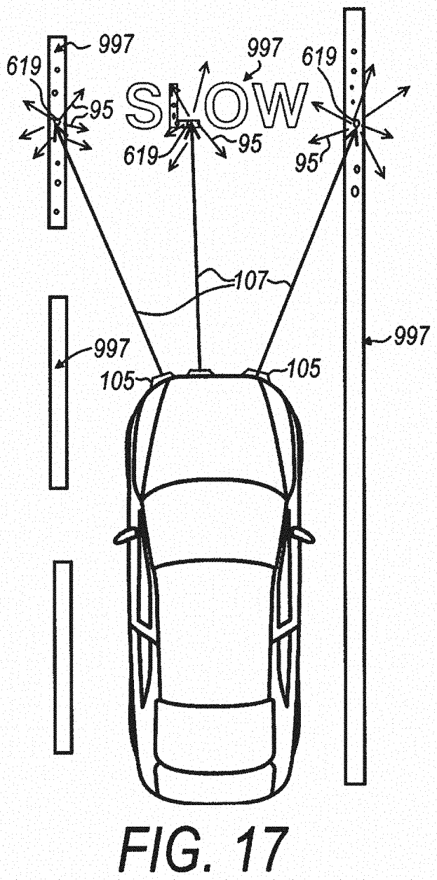

Now referring to FIG. 17, in addition to FIGS. 1 to 16, the sign 103 is configured as a road sign and the information region is configured for providing at least one of road instructions and road information. The sign 103 is but only an illustrative example of a marking enhanced with the teachings described herein, and the marking may be a road marking 997 such as part of paint deposited on the paved roadways for delimiting lanes, indicating turning lanes, speed zones, and the like. The sign 103 may be provided as a marking positioned on a vehicle. For example the sign 103 may be configured as a license plate for attachment to a rear and/or front of a vehicle or car. The sign 103 may be a sign supported by a wooden or steel post for example positioned on the side of a roadway, or may be suspended above the road way, or attached to a structure such as the supports of a bridge or of an overpass. The sign 103 described herein may be integrated into an article of clothing, such as a patch for a safety vest, or a sticker in general e.g. base 620 is configured as a sticker for adhesion to automotive related structures as well as non-automotive related structures, as an example a sticker for a helmet. The sign 103 may be embodied as a safety cone or moveable structure, for example such as those employed in constructions zones. The sign 103 may be embodied as a barrier, for example such as those employed at border crossings and tolls. Other areas of applicability of the teachings herein other than automotive is contemplated by the present disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance, It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom,” and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

The foregoing description of the embodiments has been provided for purposes of illustration and description. It is not intended to be exhaustive or to limit the disclosure. Individual elements, assemblies/subassemblies, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A sign illuminated by a light source, the light source configured to emit light in a spectral range, the sign comprising:
a base; and
a light conversion material supported by the base and configured to receive the light emitted by the light source and to convert the light into a different spectral range.

2. The sign of claim 1, further comprising a light reflective material supported by the base, the light reflective material being less efficient at reflecting the light in the spectral range and more efficient at reflecting the light in the different spectral range.

3. The sign of claim 2, wherein the light reflective material reflects the light in the spectral range being a target spectral range, and the light conversion material converts the light into the target spectral range, wherein a combination of reflected light and converted light increases an illumination intensity of the sign.

4. The sign of claim 3, wherein the light conversion material is provided as a light conversion layer overlying the light reflective material, wherein the light conversion material emits light having a spectral range matching at least a dominant spectral wavelength of light reflected by the light reflective material.

5. The sign of claim 2, wherein the light generated by the light source is in a blue spectral range.

6. The sign of claim 5, wherein the light in the blue spectral range is generated by a light source configured as a blue light emitting diode.

7. The sign of claim 5, wherein the light conversion material is configured to up-convert the received light in the blue spectral range into a spectral range matching a spectral range of light reflected by the light reflective material.

8. The sign of claim 2, wherein the light conversion material converts light in the in a blue spectral range with a peak power in a range of 450-460 nm to above the range of 450-460 nm.

1. n of claim 1, wherein the light conversion material is configured to generate light in response a photoluminescent based excitation of the light conversion material by the received light.

10. The sign of claim 9, wherein the light conversion material comprises a plurality of quantum dot particles.

11. The sign of claim 2, wherein the light conversion material is provided as a light conversion layer on at least part of the light reflective layer, wherein the light reflective layer is configured to reflect the light converted into the different spectral range.

12. The sign of claim 2, wherein the light conversion material is intermingled with the light reflective material.

13. The sign of claim 1, wherein the base supports at least one of a background region and an information region next to the background region, wherein at least one of the background region and the information region is enhanced by the light conversion material.

14. The sign of claim 13, wherein the sign is configured as a road sign and the information region is configured for providing at least one of road instructions and road information.

15. A sign illuminated by an LED lamp, comprising:
a first colored region having a first level of reflected light, the first colored region including a first dopant to reflect light incident thereon; and
a second colored region having a second level of reflected light, the second colored region including a second dopant to reflect light incident thereon;
wherein the first dopant and the second dopant are tuned so that light reflected from the first colored region is reflected at a first intensity and the second colored region is reflected at a second intensity.

16. The sign of claim 15, wherein the first dopant and the second dopant are quantum dots.

17. The sign of claim 16, further including a conversion layer on the first colored region and the second colored region, the conversion layer including a first section comprising the first dopant on the first colored region and a second section comprising the second dopant on the second colored region with the color conversion being different in second section than in the first section.

18. The sign of claim 15, wherein the LED lamp is configured to emit light predominantly having a range of blue wavelengths, and wherein at least one of the first dopant and the second dopant are tuned to emit light in response to the range of blue wavelengths.

19. The sign of claim 15, wherein the first dopant and the second dopant are tuned so that light reflected from the first colored region is reflected at a first intensity and the second colored region is reflected at a second intensity, wherein the first intensity and the second intensity are one of different and essentially the same.

20. A method of increasing an illumination intensity of a road marking illuminated by incident light emitted by a light source, comprising the steps of:
providing a reflective material efficient at reflecting light in a spectral range and absorbing light outside of the spectral range;
providing a light conversion material in association with the reflective material, the light conversion material configured to convert the incident light into light having the spectral range; and
combining the incident light reflected in the spectral range and the incident light converted into the spectral range to illuminate the road marking.
